(19) United States
(12) Patent Application Publication
(10) Pub. No.: US 2016/0363924 A1
(43) Pub. Date: Dec. 15, 2016

(54) SERVO MOTOR STOP CONTROLLER TO CONTROL AND STOP SERVO MOTOR DURING EMERGENCY STOP

(71) Applicant: FANUC CORPORATION, Yamanashi (JP)

(72) Inventor: Takahiro Tanaka, Yamanashi (JP)

(73) Assignee: FANUC CORPORATION, Yamanashi (JP)

(21) Appl. No.: 15/148,338

(22) Filed: May 6, 2016

(30) Foreign Application Priority Data
Jun. 12, 2015 (JP) 2015-119192

(51) Int. Cl. G05B 19/4063

(52) U.S. Cl. CPC G05B 19/4063; G05B 2219/50198

(57) ABSTRACT

The servo motor stop controller of the present invention outputs a stopping operation command to stop the servo motor, to the servo amplifier when the operation command output part detects an emergency stop signal. In the stop control process based on the stopping operation command, when the regenerative state detection part detects that the servo amplifier is in a regenerative state, the power supply circuit control part controls the servo power supply circuit and cuts off the power supply to the servo amplifier.

### BACKGROUND OF THE INVENTION

1. Field of the Invention

The present invention relates to a controller which controls a machine such as an industrial robot, a machine tool and a position determining device, comprising at least one moveable part driven by a servo motor. In particular, the present invention relates to a servo motor stop controller which controls and stops a servo motor during an emergency stop.

2. Related Art

In a machine tool or a robot, during an emergency, for example, when a person or obstacle intrudes into a work space or when some kind of machine failure or an abnormal operation occurs, it is necessary for the worker to immediately stop the machine and secure the safety thereof.

The stop mode of the emergency stopping function of the machine tool or robot switches depending on the level of danger, the type of emergency stop signal, the work conditions, or the like. For example, according to the IEC60204-1 standards, the stop modes are defined under the following three categories. Namely, when an emergency stop signal is detected, stop category 0 in which the power supply to the machine driving part is immediately cut off; stop category 1 in which stop control is carried out on the machine and the power supply is cut off after the machine has stopped; or stop category 2 in which stop control is carried out on the machine and the power supply is continued after the machine has stopped is selected.

When a worker carries out an emergency stop of the machine, in order to ensure that safety is the highest priority, it is desirable that the power supply to the servo amplifier is mechanically cut off so that any chance of an abnormality in the machine occurring is eliminated. Namely, when the emergency stop button is pushed by a worker, an emergency stop conforming to the stop category 0 is desirable.

Accordingly, in a conventional emergency stop method, a general stopping method is that when an emergency stop signal is detected, the power supply to the servo amplifier is instantaneously cut off to thereby interrupt the servo control and operate an electromagnetic brake or regenerative brake.

Such a conventional emergency stop method has an advantage of shortening the time and distance required from the start of the emergency stop to a complete stop but has the following problems.

FIG. 10 is a drawing explaining the conventional emergency stop method. Specifically, FIG. 10 illustrates the speed of the servo motor, opened/closed state of an electromagnetic contactor, and operation state of the brake in time charts when carrying out a conventional emergency stop method. Note that, in the graph of the speed in FIG. 10, the dotted and dashed line is the command value (command speed), and the solid line is the actual value (actual speed).

As can be seen in FIG. 10, in a conventional emergency stop method, when an emergency stop signal is detected,, the electromagnetic brake or regenerative brake is enabled at the same time that an electromagnetic contactor is closed to cut off the power supply to the servo amplifier, the braking power of these brakes is rapidly applied.

Further, when the speed command is immediately interrupted (refer to the dotted and dashed line A in FIG. 10), the servo motor rapidly decelerates and therefore, a large vibration or impact is applied to a mechanical part associated with the motor or the electromagnetic brake etc. As a result, a sudden change appears in the curved line indicating the actual speed of the servo motor (refer to solid line B in FIG. 10). Namely, after detecting the emergency stop signal, the servo motor does not smoothly decelerate to a stop.

Further, such vibrations or impacts during an emergency stop have a risk of damaging the machine and have the possibility of the fastening between components becoming loose and thereby the positional accuracy of the machine being reduced. Further, if vibrations or impacts are large during an emergency stop, there is a risk in which, for example, a tool mounted to a machine tool interferes with and damages an equipment which exists in the periphery of the tool or an object to be machined.

Further, in cases that the speed command is interrupted and the operation is stopped by the braking power of the electromagnetic brake or the regenerative brake, coasting which largely deviates from a trajectory programmed in advance may occur. Such cases lead to problems, such as injury to workers in the vicinity of the machine, or delays in repair work for the reoperation of the machine.

Further, in Japanese laid-open Patent Application No. 2014-34108 or Japanese laid-open Patent Application No. 2003-25271, etc., a stopping method which reduces vibrations or impacts during an emergency stop has been proposed.

For example, Japanese laid-open Patent Application No. 2014-34108 discloses a stopping method in which during an emergency stop the power supply to the servo amplifier is cut off, and a charge/discharge part capable of being charged and discharged is charged with regenerative current which is generated by decelerating a servo motor, whereby the electric power charged to the charge/discharge part continues to run the stop control of the servo motor.

Further, Japanese laid-open Patent Application No. 2003-25271 discloses a stopping method in which a servo motor is decelerated by the stop control until the speed is below a predetermined safe speed, and once the servo motor is below a safe speed, the servo control is interrupted to switch to an electromagnetic brake.

However, in the stopping method disclosed in Japanese laid-open Patent Application No. 2014-34108, if an emergency stop is carried out while the servo motor is accelerating or, if the electromagnetic brake is operated immediately after emergency braking, there is a risk in which the stop control cannot be safely carried out. Namely, in such cases if the servo motor is tried to decelerate smoothly by the stop control, the power in the charge/discharge part is consumed in a short time, so that the direct-current voltage in the servo amplifier is reduced and the servo control becomes unstable.

On the other hand, in the stopping method disclosed in Japanese laid-open Patent Application No. 2003-25271, the electromagnetic brake is operated after the servo motor has decelerated to a predetermined speed. Accordingly, there is an effect of preventing vibrations or impacts during an emergency stop to a certain degree. However, the electromagnetic brake is operated during inertial rotation of the servo motor, and thus the vibrations or impacts cannot be completely removed. In particular, if the braking power of the electromagnetic brake is large, there is the possibility that the expected shock resistance effect cannot be obtained.

Further, in the stopping method disclosed in Japanese laid-open Patent Application No. 2003-25271, during an emergency stop the primary power supply is immediately shut off, like in Japanese laid-open Patent Application No. 2014-34108. As a result, if an emergency stop is carried out while the servo motor is accelerating, the direct-current voltage in the servo amplifier is reduced, and therefore there is a risk in which the stop control cannot be carried out safely.

### SUMMARY OF THE INVENTION

The present invention provides a servo motor stop controller in which the power supply to the servo amplifier is cut off during an emergency stop and the servo motor can be safely and reliably stopped.

According to a first aspect of the present invention, there is provided a servo motor stop controller which stops and controls at least one servo motor which drives a movable part of a machine tool or a robot, during an emergency stop, comprising a position detector which detects the axial position of the servo motor, at least one servo amplifier which drives the servo motor, at least one servo power supply circuit which supplies power to the servo amplifier, a servo motor control unit which controls the servo motor via the servo amplifier based on the axial position detected by the position detector, an electromagnetic brake or a regenerative brake which brakes the shaft rotation of the servo motor, and an emergency stop signal output part, provided on the outside or inside of the servo motor control unit, outputting an emergency stop signal.

Further, the servo motor control unit of the first aspect comprises an operation command output part which detects the emergency stop signal, and generates and outputs a stopping operation command to stop the servo motor, a regenerative state detection part which detects the regenerative state of the servo amplifier, and a power supply circuit control part which controls the servo power supply circuit and supplies or cuts off power to the servo amplifier, wherein, when the operation command output part detects the emergency stop signal, the stopping operation command is output to the servo amplifier, and in the step of stop control based on the stopping operation command, the regenerative state of the servo amplifier is detected by the regenerative state detection part, the power supply circuit control part is configured to control the servo power supply circuit whereby the supply of power to the servo amplifier is cut off.

According to a second aspect of the present invention, there is provided the servo motor stop controller of the first aspect wherein the servo amplifier further comprises a charge/discharge part which is charged by the regenerative current generated during the deceleration operation of the servo motor, wherein, after the power supply to the servo amplifier has been cut off, the servo motor control unit is configured to continue the stop control based on the stopping operation command until the stop control ends, by use of the regenerative electric power charged to the charge/discharge part of the servo amplifier.

According to a third aspect of the present invention, there is provided the servo motor stop controller of the first and second aspects, wherein, if the duration of the servo power supply circuit maintaining the power supply to the servo amplifier, from the detection of the emergency stop signal by the operation command output part, exceeds a predetermined maximum retention time, the power supply circuit control part controls the servo power supply circuit and forces the power supply to the servo amplifier to be cut off.

According to a fourth aspect of the present invention, there is provided the servo motor stop controller of the first to third aspects, wherein, after the power supply circuit control part controls the servo power supply circuit to interrupt the power supply to the servo amplifier in response to the detection of the servo amplifier being in a regenerative state by the regenerative state detection part, if the regenerative state detection part detects that the servo amplifier is in a power running state, the power supply circuit control part controls the servo power supply circuit to restore the power supply to the servo amplifier and the servo motor control unit is configured to continue the stop control based on the stopping operation command until the end of the stop control.

According to a fifth aspect of the present invention, there is provided the servo motor stop controller of the first to fourth aspects, wherein, after the detection of the emergency stop signal, if a position deviation amount, which is calculated from the stopping operation command and the shaft position of the servo motor detected by the position detector, exceeds a first specified value during the period from when the servo motor control unit carries out the stop control based on the stopping operation command to when the servo motor control unit terminates the stopping operation, the servo motor control unit is configured to interrupt the output of the stopping operation command, enable the electromagnetic brake or the regenerative brake, and switch off the power to the servo motor.

According to a sixth aspect of the present invention, there is provided the servo motor stop controller of any one of the first to fifth aspects, wherein, after the detection of the emergency stop signal, if the direct current voltage in the servo amplifier is less than a second specified value during the period from when the servo motor control unit carries out the stop control based on the stopping operation command to when the servo motor control unit terminates the stop control, the servo motor control unit is configured to interrupt the output of the stopping operation command, enable the electromagnetic brake or regenerative brake, and switch off the power to the servo motor.

According to a seventh aspect of the present invention, there is provided the servo motor stop controller of any one of the first to sixth aspects, wherein, after the detection of the emergency stop signal, if the shaft position of the servo motor detected by the position detector exceeds a predetermined maximum control stopping distance during the period from when the servo motor control unit carries out the stop control based on the stopping operation command to when the servo motor control unit terminates the stop control, the servo motor control unit is configured to interrupt the output of the stopping operation command, enable the electromagnetic brake or the regenerative brake, and switch off the power to the servo motor.

According to an eighth aspect of the present invention, there is provided the servo motor stop controller of any one of the first to seventh aspects, wherein, after the detection of the emergency stop signal, if the time for carrying out the stop control exceeds a predetermined maximum control stop time during the period from when the servo motor control unit carries out the stop control based on the stopping operation command to when the servo motor control unit terminates the stop control, the servo motor control unit is configured to interrupt the output of the stopping operation command, enable the electromagnetic brake or the regenerative brake, and switch off the power to the servo motor.

According to a ninth aspect of the present invention, there is provided the servo motor stop controller of any one of the first to sixth aspects, wherein, after the detection of the emergency stop signal, when the servo motor control unit has carried out the stop control based on the stopping operation command, and terminated the stop control, the servo motor control unit is configured to enable the electromagnetic brake or the regenerative brake and switch off the power to the servo motor.

### BRIEF DESCRIPTION OF THE DRAWINGS

The above mentioned objects, features, and advantages and other objects, features and advantages of the present invention will become more apparent from the following detailed description of the exemplary embodiments of the present invention illustrated in the accompanying drawings in which:

FIG. 1 is a block diagram illustrating the servo motor stop controller according to an embodiment of the present invention.

FIG. 2 is a flow chart illustrating the main control flow of the servo motor stop controller indicated in FIG. 1.

FIG. 3 is a time chart illustrating the effect of the stop control indicated in FIG. 2.

FIG. 4 is a time chart illustrating a further effect of the stop control indicated in FIG. 2.

FIG. 5 is a flow chart illustrating a preferred first control flow in the stop control during an emergency stop illustrated in FIG. 2.

FIG. 6 is a time chart illustrating the effect of the first control flow illustrated in FIG. 5.

FIG. 7 is a flowchart illustrating a preferred second control flow in the stop control during an emergency stop illustrated in FIG. 2.

FIG. 8 is a flowchart illustrating a preferred third control flow in the stop control during an emergency stop illustrated in FIG. 2.

FIG. 9 is a time chart illustrating the effect of the third control flow illustrated in FIG. 8.

FIG. 10 is a drawing explaining the conventional emergency stop method.

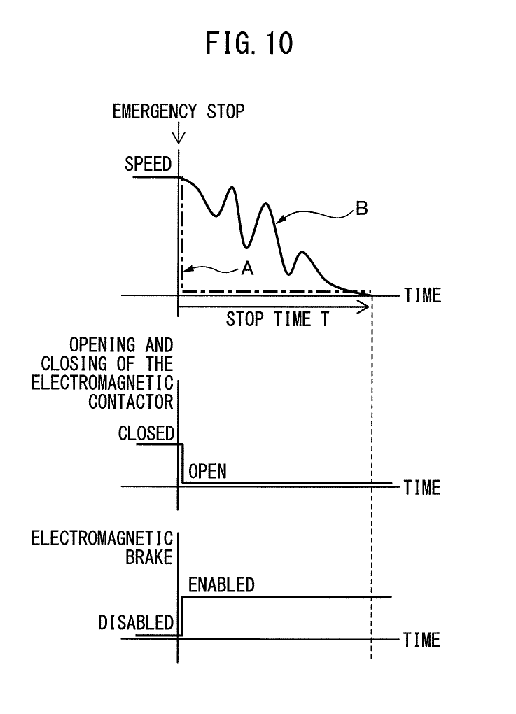

### DETAILED DESCRIPTION

Hereinafter, embodiments of the present invention will be described referring to the drawings. The same reference numerals for the same or corresponding constitutional elements are used over the drawings. The scale of the drawings showing the constitutional elements of the illustrated embodiments has appropriately been adjusted so as to facilitate the understanding of the present inventions. Further, the following explanation of the servo motor stop controller is exemplified by the application thereof to a machine tool or a robot. However, the present inventions are not limited thereto.

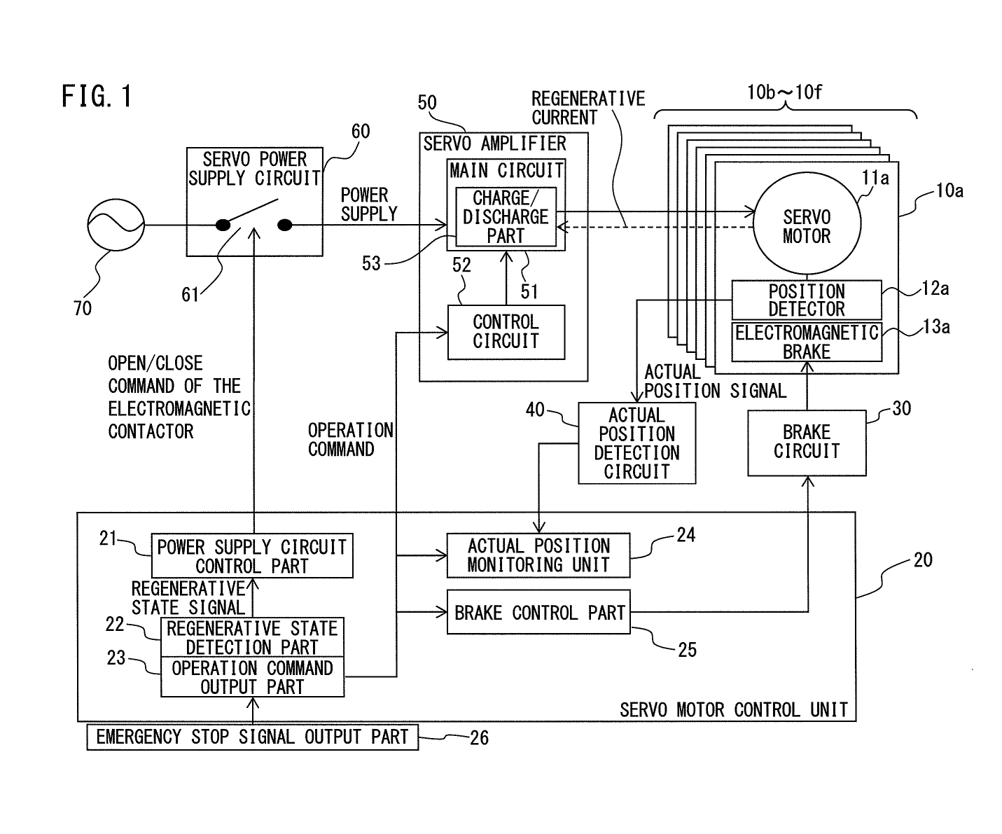

FIG. 1 is a block diagram illustrating the main control flow of the servo motor stop controller according to an embodiment of the present invention.

According to FIG. 1, the servo motor control unit of the present embodiment comprises at least one motor unit 10a to 10f which drives a movable part (not illustrated) of a machine tool or a robot.

The motor units 10a to 10f respectively comprise servo motors 11a to 11f which drive the moveable part, and position detectors 12a to 12f and electromagnetic brakes 13a to 13f which are respectively provided on the servo motors 11a to 11f. Note that, in the description of the embodiments below an explanation of the stop control is given with respect to a representative servo motor 11a.

The servo motor 11a of the present embodiment can be applied to various machines driven by a servo motor, for example, an industrial robot, a machine tool, a horizontal shaft moving device which uses a linear motor, a position determining device comprising a servo motor and a decelerator. Further, the industrial robot is, for example, a vertically articulated robot, and the machine tool is, for example, a machining center or a milling machine, etc.

Further, as illustrated in FIG. 1, the servo motor control unit of the present embodiment, comprises at least one servo amplifier 50 which drives the servo motor 11a, and one or more servo power supply circuits 60 which supply power to the servo amplifier 50 from an AC power source 70, a servo motor control unit 20 which electrically controls the servo motor 11a via the servo amplifier 50, an actual position detection circuit 40 which feeds back the actual position signal of the shaft positions of each servo motor detected by the position detector 12a to the servo motor control unit 20, a brake circuit 30 which supplies a brake driving power source to the electromagnetic brake 13a based on a switch command from the servo motor controller 20, and an emergency stop signal output part 26 which outputs an emergency stop signal.

Note that, the emergency stop signal may be, for example, a stop signal output from an emergency stop button provided on an operation panel of the machine tool or robot etc. or, from an area sensor or an obstacle sensor which detects the intrusion of a person or an obstacle in the workspace of a machine tool or robot. Further, the emergency stop signal is not limited to an emergency stop signal output from an emergency stop signal output part 26 provided on the outside of the servo motor control unit 20, such as an emergency stop button provided on an operation panel or an area sensor etc. For example, a circuit which detects abnormal states or failures of the servo amplifier 50 or the position detector 12a etc. may be built into the servo motor control unit 20, and the signal output from the circuit may be used as an emergency stop signal.

Regarding the position detection device 12a, a feedback device, for example, an encoder is used to feed back the detected shaft position of the servo motor 11a to the actual position detection circuit 40. Further, the electromagnetic brake 13a may be of a type in which a friction braking member is driven by a solenoid, to be pressed against the shaft of the servo motor 11a to brake the rotation of the shaft of the servo motor 11a by friction. Further, FIG. 1 illustrates the motor unit 10a in which the position detector 12a and electromagnetic brake 13a are attached to the servo motor 11a. However, the present invention is not limited hereto. The position detector 12a and the electromagnetic brake 13a may be provided outside the motor unit 10a. For example, the position detector 12a may be a position detector which detects the position of an operation shaft connected directly or indirectly to the shaft of the servo motor 11a or, instead of the encoder, a linear scale may be used for the position detector 12a. Further, the electromagnetic brake 13a may be a mechanical brake which brakes the rotation of such an operating shaft.

The servo amplifier 50 comprises, a main circuit 51 that is composed of an inverter circuit (not illustrated) which electrically generates AC current from DC power, a capacitor (not illustrated) as a charge/discharge part 53, and the like, and a control circuit 52 which controls the servo motor 11a based on the operation command from the servo motor control unit 20.

The supply of power to the servo motor 11a is carried out by the servo amplifier 50. At this time, direct-current voltage applied via a pair of power lines (not illustrated) from the servo power supply circuit 60, for example a bus voltage is changed to AC voltage of a predetermined frequency by an inverter circuit (not illustrated) in the main circuit 51 in the servo amplifier 50 and is supplied to the servo motor 11a.

On the other hand, when decelerating the servo motor 11a, energy is regenerated from servo motor 11a to the servo amplifier 50. Accordingly, the direct-current voltage in the servo amplifier 50 increases, and the capacitor (not illustrated) as a charge/discharge part 53 that is connected between power lines extending from the servo power supply circuit 60 is charged thereby.

In the present embodiment, the electromagnetic brake 13a which brakes the servo motor is provided in the motor unit 10a. However in the present invention, the electromagnetic brake 13a and an unillustrated regenerative brake (dynamic brake) may be provided. Namely, braking power generated from an unillustrated regenerative brake may be used to stop the servo motor 11a.

Note that, electromagnetic brake 13a is enabled in response to a switch command output to the brake circuit 30 from the servo motor control unit 20, when the stop control has finished based on the operation command or, when the stop control is interrupted. On the other hand, the unillustrated regenerative brake is enabled in response to an unillustrated regenerative brake signal output to the control circuit 52 of the servo amplifier 50 from the servo motor control unit 20 when the stop control is interrupted and the power supply is cut off to the servo amplifier 50.

The brake circuit 30 is a circuit which supplies a brake power source which opens and closes the electromagnetic brake 13a based on a switch command from the servo motor control unit 20. Examples of the brake circuit 30 include an electric circuit having a transistor, or an electric circuit having a relay, etc.

The servo power supply circuit 60 comprises an electromagnetic contactor 61 which supplies and cuts off the power supply to the servo amplifier 50. Further, the power supply to the servo amplifier 50 is cut off by opening the contact of the electromagnetic contactor 61 according to the open/close command from the servo motor control unit 20.

The servo motor control unit 20 comprises an actual position monitoring unit 24 which monitors the actual position signal fed back from the position detector 12a of the servo motor 11a via the actual position detection circuit 40; an operation command output part 23 which generates an operation command to stop the servo motor 11a and outputs the same to the servo amplifier 50 when the emergency stop signal output from the emergency stop signal output part 26 is detected; a regenerative state detection part 22 which detects whether or not the servo amplifier 50 is in a regenerative state; a power supply circuit control part 21 which controls the opening and closing of the contact of the electromagnetic contactor 61 in the servo power supply circuit 60 based on the regenerative state signal from the regenerative state detection part 22; and a brake control part 25 which outputs a switch command to switch the electromagnetic brake 13a between disabled and enabled, to the brake circuit 30. These constituent parts are constructed from input/output circuits using electronic components such as a CPU, ROM and RAM. Of course, such input/output circuits are connected to power input lines (not illustrated).

The operation command generated by the operation command output part 23 includes servo control commands such as position commands, speed commands and motor torque commands. Furthermore, while the power is out, in order for the servo motor control unit 20 to function, it is preferable for the servo motor control unit 20 to have a rechargeable battery built in, in addition to the power input line (not illustrated).

The regenerative state detection part 22, with reference to the position command, speed command, motor torque command, etc., generated by the operation command output part 23, detects whether the servo amplifier 50 is in a regenerative state. Specifically, the regenerative state detection part 22 judges that the servo amplifier 50 is in a regenerative state, if the motor torque command is a command to generate a regenerative current from the servo motor 11a, the acceleration command is a command to generate a regenerative current from the servo motor 11a, or the command speed is less than the actual speed of the servo motor. Further, the judgments based on these conditions may be carried out simultaneously.

Note that, the regenerative state detection part 22 of the present embodiment detects the regenerative state of the servo amplifier 50 with reference to the operation command issued by the operation command output part 23. However, it is not limited thereto. For example, the regenerative state detection part 22 may detect the regenerative state of the servo amplifier 50 by monitoring the direct-current voltage in the servo amplifier 50.

Further, FIG. 1 illustrates one servo power supply circuit 60, one servo amplifier 50, and six motor units 10a to 10f (six servo motors). However, the present invention is not limited to those numbers.

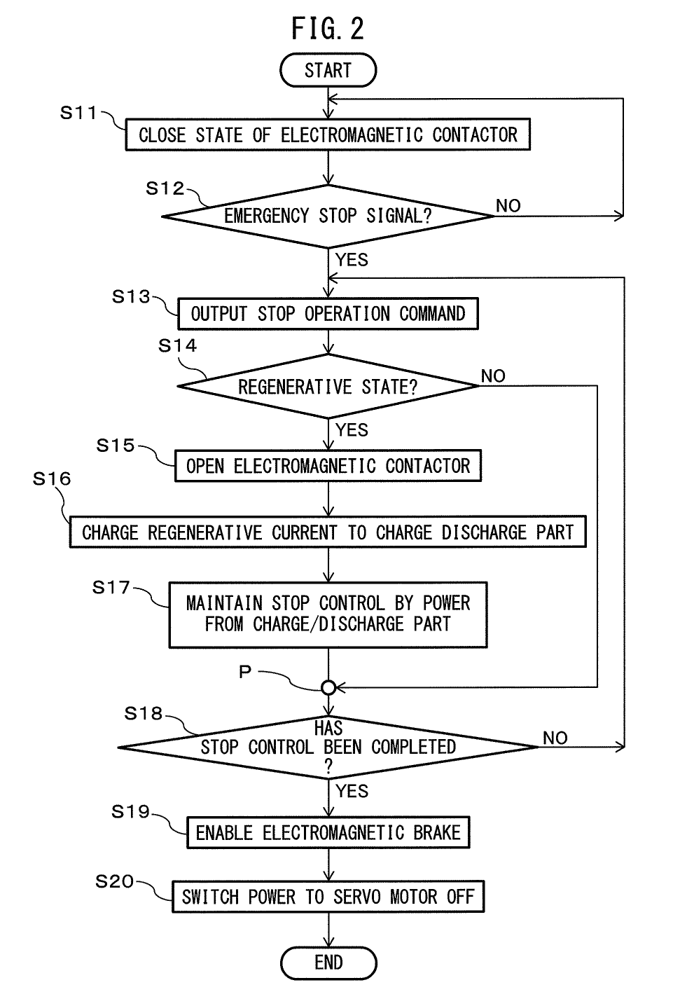

Next, FIG. 2 will be described with reference to the operation of the servo motor stop controller illustrated in FIG. 1, specifically with regard to the stop operation during an emergency stop.

FIG. 2 is a flowchart illustrating the main stop control flow of the servo motor stop controller shown in FIG. 1. Note that, FIG. 2 illustrates a stop operation if an emergency stop signal is input when the servo motor 11a operates following a predetermined operation command.

When the servo motor 11a is following a predetermined operation command, the power supply circuit control part 21 is in a state where the contacts of the electromagnetic contactor 61 are closed, namely the power supply to the servo amplifier 50 is secured (FIG. 2, step S11). At that time, as illustrated in FIG. 2, if the operation command output part 23 detects an emergency stop signal (step S12), the operation command output part 23 generates a stopping operation command and outputs the same to the control circuit 52 of the servo amplifier 50 (step S13) to smoothly decelerate and stop the servo motor 11a which is operating. Note that, the output stopping operation command is a command which, by following a trajectory programmed in advance based on trajectory planning, a machine tool or a movable part of a machine tool or a robot, for example, a spindle head or a robot arm, driven by the servo motor 11a, can be smoothly decelerated and stopped.

Next, the regenerative state detection part 22 judges whether the servo amplifier 50 has switched to the regenerative state, namely whether regenerative current generated from the servo motor 11a flows to the servo amplifier 50 (step S14). Accordingly, the regenerative state detection part 22 detects the regenerative state of the servo amplifier 50 with reference to the stopping operation command output from the operation command output part 23 to the servo amplifier 50, for example, the aforementioned torque command, acceleration command or the direct-current voltage in the servo amplifier 50.

Further, when the regenerative state detection part 22 detects the regenerative state, the power supply circuit control part 21 outputs a command signal to open the contacts of the electromagnetic contactor 61 of the servo power supply circuit 60 to thereby cut off the power supply to the servo amplifier 50 (step S15). Furthermore, the regenerative current from the servo motor 11a is charged to the charge/discharge part 53 in the main circuit 51 of the servo amplifier 50 (step S16), and the servo motor control unit 20, maintains the stop control of the servo motor 11a (step S17) by use of the power from the charge/discharge part 53. Namely, the servo motor 11a, by using the power from the charge/discharge part 53, performs the operation in accordance with the stopping operation command from the operation command output part 23.

Further, in the aforementioned step S14, if the regenerative state detection part 22 does not detect a regenerative state, the power supply circuit control part 21 does not open the contacts of the electromagnetic contactor 61 and the power supply to the servo amplifier 50 is secured, until a regenerative state is detected by the regenerative state detection part 22. In such cases, the servo motor 11a powered by the servo power supply circuit 60 follows the control of the stopping operation command of the operation command output part 23.

In the present embodiment, the aforementioned steps S13 to S17 are repeated until the stopping operation command output from the operation command output part 23 is completed. Further, when the stopping operation command is completed (step S18), the brake control part 25 enables the electromagnetic brake 13a (step S19). Specifically when the brake control part 25 outputs a switch command to the brake circuit 30, the brake circuit 30 cuts off the brake power source supplied to the electromagnetic brake 13a, as a result the electromagnetic brake 13a brakes the rotation of the shaft of the servo motor 11a.

Thereafter, the servo motor control unit 20 switches off the power to the servo motor 11a and the servo control ends (step S20). Specifically, in step S14, if the regenerative state has not been detected, in addition to the power supply to the servo amplifier 50 from the AC power source 70 being cut off, the power to the servo motor 11a is switched off and the servo control ends. On the other hand, if the regenerative state is detected in step S14, the power supply to the servo motor 11a from the charge/discharge part 53 in the servo amplifier 50 is stopped and the servo control ends.

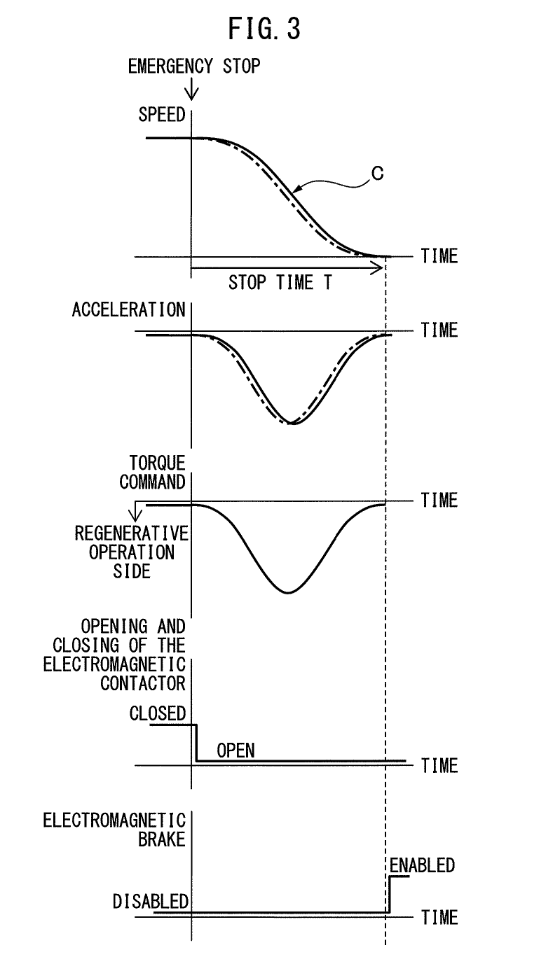

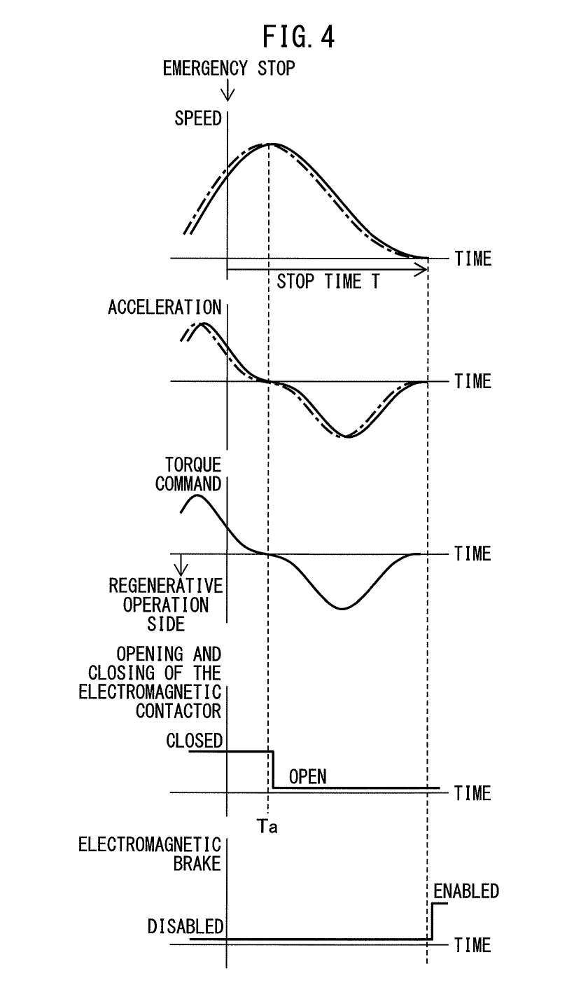

The effect of the stop control of the present invention will be described based on FIG. 3 and FIG. 4.

FIG. 3 and FIG. 4 are time charts which show the effect of the stop control illustrated in FIG. 2. In particular, both FIG. 3 and FIG. 4 are time charts illustrating each of the speed, acceleration, torque command, open/closed state of the electromagnetic contactor, and the operation state of the brake of the servo motor when stop control of the present invention is carried out. Note that, in the graphs for speed and acceleration in FIG. 3 and FIG. 4, the dotted and dashed lines represent command values and the solid lines represent actual values.

As can be understood from the time charts of speed, acceleration and torque command illustrated in FIG. 3, on detecting the emergency stop signal, an operation command is output which smoothly decelerates and stops the servo motor 11a. In the present invention, in such a stop control process, if it is detected that the servo amplifier 50 has switched to the regenerative state, the contacts of the electromagnetic contactor 61 of the servo power supply circuit 60 are opened and the power supply to the servo amplifier 50 is cut off.

Namely, if the torque command is on the side of the regenerative operation, the contacts of the electromagnetic contactor 61 are made to open.

Further the stop control of the servo motor 11a is maintained by the regenerative electric power charged to the charge/discharge part 53 in the servo amplifier 50.

Thus, as can be seen by the solid line representing speed, acceleration and torque command in each of the graphs in FIG. 3., the torque command for deceleration and stopping, continues after the electromagnetic contactor is in an open state, the speed of the servo motor, as shown by the curved line C, smoothly and gradually approaches zero. Namely, after detecting the stop signal, the servo motor smoothly decelerates and stops. Further, in the present application, after detecting the stop signal, the electromagnetic brake 13a does not immediately act on the servo motor 11a, but is enabled after stop control ends.

FIG. 4 shows the speed characteristic of the servo motor 11a when an emergency stop signal is detected while accelerating, until the servo motor 11a stops. If an emergency stop signal is detected during acceleration of the servo motor 11a, in the present embodiment as illustrated in FIG. 4, in the process of stop control, until the servo amplifier 50 has switched from a power running state to a regenerative state, the contacts of the electromagnetic contactor 61 of the servo power supply circuit 60 are kept in a closed state (refer to Ta in the drawing). Namely, in the present embodiment, after detecting the stop signal, when the servo amplifier 50 switches to a regenerative state, the power supply to the servo amplifier 50 is cut off.

In general, to smoothly stop the servo motor 11a which is operating at a certain speed and acceleration, while maintaining the continuity of the speed command and acceleration command, it is necessary to transit the speed and acceleration to zero.

For example, if an emergency stop signal is input while the servo motor 11a is accelerating, to smoothly stop the servo motor 11a, as illustrated in the graph of speed in FIG. 4, an acceleration operation (power running operation) is always required for a fixed period immediately after the emergency stop. If the power supply to the servo amplifier 50 during the acceleration operation is cut off, the power charged to the charge/discharge part 53 in the servo amplifier 50 will be consumed in a short time. Accordingly, the direct-current voltage in the servo amplifier 50 will decrease and there is a risk that stop control cannot be carried out safely.

In order to prevent such a state from occurring, in the present invention, from when the emergency stop signal is detected to when the operation command switches to the decelerate operation (regenerative operation), the power supply to the servo amplifier 50 is maintained by keeping the contacts of the electromagnetic contactor 61 closed. Accordingly, even if an emergency stop signal is input while the servo motor is accelerating, the servo motor 11a can be safely and smoothly stopped.

Further, after the operation command has switched to the decelerate operation (regenerative operation), the stop mode is quickly switched from stop category 1 to stop category 0 by opening the contacts of the electromagnetic contactor 61 so as to cut off the power supply to the servo amplifier. Accordingly, it is possible to eliminate the occurrence of an abnormal operation when the power source for a machine is cut off, and safe emergency stop control can be carried out.

### Other Embodiments

Next, other embodiments will be described. Note that, points different from the aforementioned embodiments will mainly be described and the same reference numerals will be used for the same constitutional components as in the aforementioned embodiments and a description therefor will be omitted.

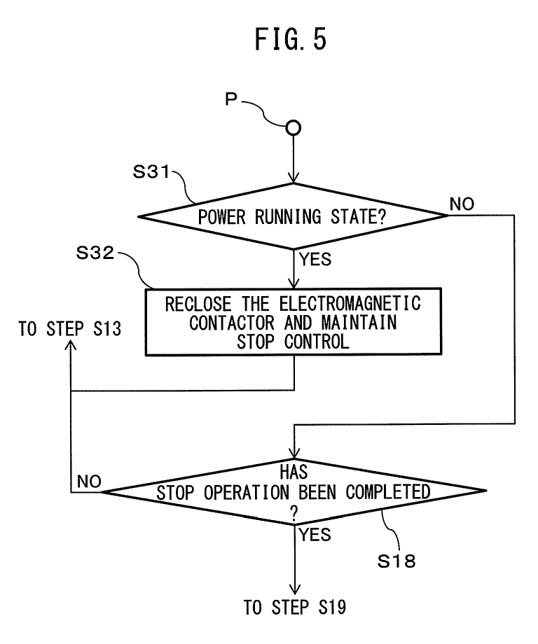

FIG. 5 is a flow chart illustrating a preferred first control flow in the stop control during an emergency stop illustrated in FIG. 2.

In the above embodiment, as can be seen in step S14 to step S18 of FIG. 2, after the regenerative state has been detected, the contacts of the electromagnetic contactor 61 are opened and the power supply to the servo amplifier 50 is cut off, the regenerative current charges the charge/discharge part 53 in the servo amplifier 50, and the stopping operation command from the operation command output part 23 is maintained by the charged power. At this time, there are cases where the servo motor 11a switches from a decelerate operation (regeneration operation) to the acceleration operation (power running operation) again or a coasting state. In such cases, the power charged to the charge/discharge part 53 of the main circuit 51 in the servo amplifier 50 is consumed in a short time, the direct-current voltage in the servo amplifier 50 is decreased and there is a risk that stop control cannot be carried out safely.

Based on this, it is preferable that the first control flow illustrated in FIG. 5 is inserted between point P after step S17 and step 18 illustrated in FIG. 2. Specifically, as shown in FIG. 5, after point P, the regenerative state detection part 22 judges whether the servo amplifier 50 is in a power running state or in a coasting state (step S31). If a power running state or a coasting state is not detected by the regenerative state detection part 22, the control passes to step S18. Namely, the servo motor control unit 20 maintains stop control until the stopping operation command of the operation command output part 23 ends. On the other hand, in step S31, if the regenerative state detection part 22 detects that the servo amplifier 50 is in a power running state or in a coasting state, namely a regenerative state is not detected, the power supply circuit control part 21 recloses the contacts of the electromagnetic contactor 61, restores the power supply to the servo amplifier 50 and maintains the stop control with the power (step S32). After step 32, the control is returned to step S13 as shown in FIG. 2.

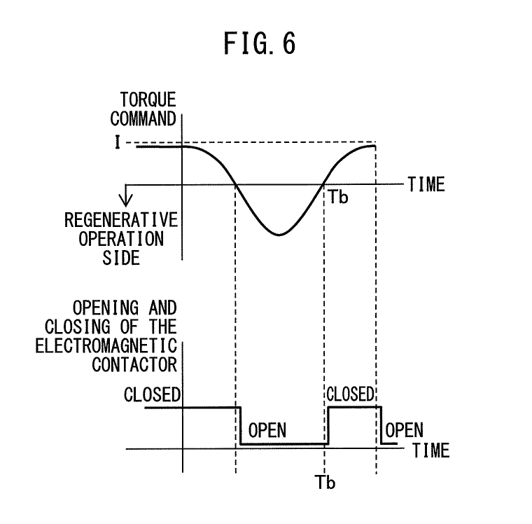

FIG. 6 is a time chart illustrating the effect of the first control flow illustrated in FIG. 5. Specifically, FIG. 6 is a time chart respectively showing the torque command and opened/closed state of the electromagnetic contactor of the servo motor in the case first control flow of FIG. 5 is applied to the stop control flow of FIG. 2.

As can be seen in the torque command graph of FIG. 6 (specifically refer to the time Tb), after detecting the stop signal, even if the torque command is temporarily on the regenerative operation side, the torque command may switch back to the power running operation side. For example, when a robot is in a stopped state, in order for the robot to support its own weight, a certain degree of torque is required on the shaft of the servo motor (refer specifically to torque value I). Accordingly, the value indicative of the regenerative operation for the torque command for decelerating and stopping at time Tb in FIG. 6 may switch to the value indicative of the power running operation. In such cases, as illustrated in FIG. 6, the contacts of the electromagnetic contactor 61 may be switched from the open to the closed state, restoring the power supply to the servo amplifier 50 and ensuring that the stop control is safely maintained.

Furthermore, regarding the stop control flow during an emergency stop, as shown in FIG. 2, it may be applied not only to the aforementioned first control flow but also at least one of a second control flow and third control flow as follows.

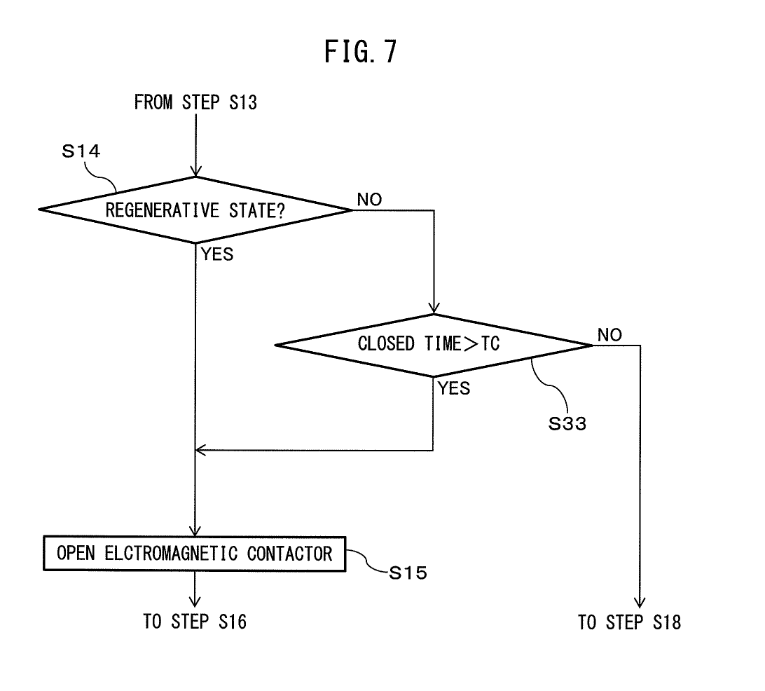

FIG. 7 is a flowchart illustrating the preferred second control flow in the stop control during an emergency stop illustrated in FIG. 2.

In the stop control during an emergency stop illustrated in FIG. 2, after detecting the emergency stop signal, until the regenerative state of the servo amplifier 50 is detected, the contacts of the electromagnetic contactor 61 are closed and the power supply to the servo amplifier 50 is not cut off (refer to FIG. 2, steps S12 to S15). However, in order to eliminate the possibility of an abnormal operation in the machine occurring, it is preferable to open the contact of the electromagnetic contactor 61 as early as possible to cut off the power supply to the servo amplifier 50.

It is preferable that the second control flow as shown in FIG. 7 is inserted between step S14 and step S15 as shown in FIG. 2. Specifically, as shown in FIG. 7, even if the regenerative state detection part 22 judges that the servo amplifier 50 is not in a regenerative state, the period the servo power supply circuit 60 maintains the power supply to the servo amplifier 50 from when the emergency stop signal is detected, namely whether the period of time that electromagnetic contactor 61 is closed exceeds the maximum retention time Tc be determined (FIG. 7, step S33).

In step S33, when the period of time that electromagnetic contactor 61 is closed exceeds the maximum retention time Tc, the servo motor control unit 20 opens the contacts of the electromagnetic contactor 61, to forcibly cut off the power supply to the servo amplifier 50 (FIG. 7, step S15), and maintains the stop control of the servo motor 11a by the regenerative electric power charged to the charge/discharge part 53. On the other hand, when the period of time that electromagnetic contactor 61 is closed does not exceed the maximum retention time Tc, the servo motor control unit 20 maintains the stop control and does not cut off the power supply to the servo amplifier 50 until the regenerative state of the servo amplifier 50 is detected.

According to such a second control flow, when, from the detection of the emergency stop signal the period of time that electromagnetic contactor 61 is closed, exceeds a maximum retention time Tc, the power supply to the servo amplifier 50 can be forcibly cut off without waiting for the switching of the servo amplifier 50 from the power running state or the coasting state to the regenerative state in the highest priority to safety.

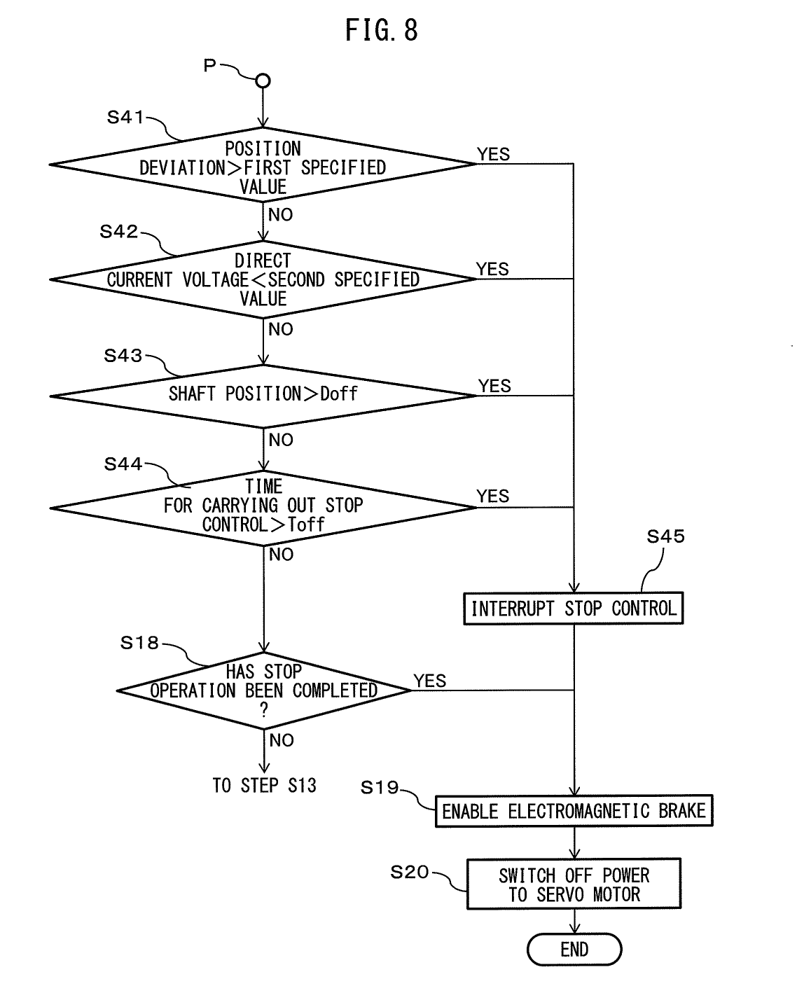

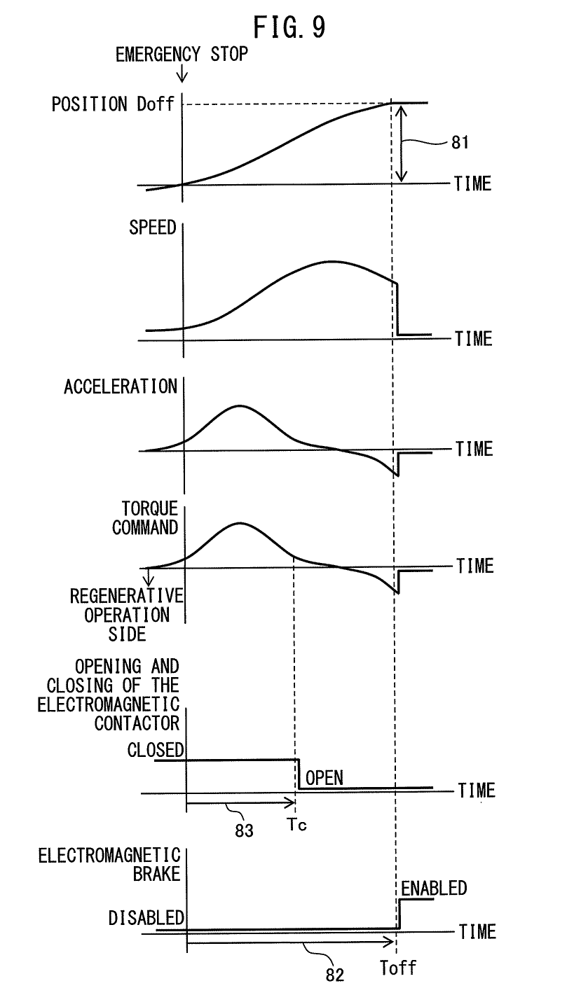

FIG. 8 is a flowchart illustrating the preferred third control flow in the stop control during an emergency stop illustrated in FIG. 2. Further, FIG. 9 is a time chart showing the effect of the third control flow illustrated in FIG. 8. Specifically, FIG. 9 is a time chart which shows each of the position of the shaft of the servo motor, speed, acceleration and torque command, opened/closed state of an electromagnetic contactor, and the operative state of the electromagnetic brake when the third control flow shown in FIG. 8 is applied to the stop control flow of FIG. 2.

In the stop control during an emergency stop illustrated in FIG. 2, if the servo amplifier 50 switches from a power running state to a regenerative state, the power to the servo amplifier 50 is cut off, stop control is maintained by the regenerative electric power charged to the charge/discharge part 53 in the servo amplifier 50 and the servo motor 11a is smoothly stopped. Thereafter, the electromagnetic brake 13a is enabled and the power supply to the servo motor 11a is switched off (refer specifically to FIG. 2, steps S17 to S20). However, the present invention is not limited to such a stop control. In order to realize an even safer stop control, it is preferable that the third control flow illustrated in FIG. 8 is inserted between point P and step S18 illustrated in FIG. 2. The third control flow will be explained below with reference to FIGS. 8 and 9.

As illustrated in FIG. 8, after point P (refer to FIG. 2), the servo motor control unit 20 calculates and monitors the position deviation amount in each shaft space and Cartesian space (namely, the amount of deviation of the positions in each axial direction and the positions in Cartesian space, of the x-axis, y-axis and z-axis in an Cartesian coordinate system), on the basis of the operation command generated by the operation command output part 23 and the actual position of the shafts of each servo motor monitored by the actual position monitoring unit 24. For example, in a vertically articulated robot there is an operating shaft at each joint, and in a machine tool, operation shafts are mutually perpendicular. For example, as shown in FIG. 1, the motor units 10a to 10f (six servo motors) are provided for the respective shafts. In order to move the tool at the tip of the robot to a predetermined location in space, an operation command is generated for each shaft, and each shaft is operated while monitoring the amount of deviation between the actual position and the command position, of each shaft that has moved according to the operation command. At this time, if the position deviation amount of each shaft space and the Cartesian space is abnormally large, there is a risk in which the tool will not move to the target position. Accordingly, as illustrated in FIG. 8, the servo motor control unit 20 judges whether or not the position deviation amount exceeds a first specified value (step S41).

If the position deviation amount exceeds the first specified value, the servo motor control unit 20 interrupts the stop control, namely, the output of the operation command to decelerate and stop the servo motor 11a is interrupted (step S45) and the electromagnetic brake 13a is enabled (step S19). Then the servo motor control unit 20 switches off the power supply to the servo motor 11a and the servo control ends (step S20). To elaborate on step S20, if the regenerative state has not been detected in step S14, the power supply from the AC power source 70 to the servo amplifier 50 is cut off, the power supply to the servo motor 11a is stopped and the servo control ends. Namely, in step S45 if the output of the operation command is interrupted, the electromagnetic brake 13a is enabled, and it is preferable that if the power supply to the servo amplifier 50 is not cut off, the power supply be cut off. On the other hand, in step S14, if the regenerative state is detected, the power supply to the servo motor 11a from the charge/discharge part 53 in the servo amplifier 50 is stopped and the servo control ends. Note that, if the servo motor 11a comprises a regenerative brake (not illustrated), it is preferable to operate the regenerative brake after stopping the power supply to the servo motor 11a as described above.

Further, in the aforementioned step S41, if the position deviation amount does not exceed the specified value, servo motor control unit 20 judges whether or not the direct-current voltage in the servo amplifier 50 is lower than a second specified value (step S42). If the direct-current voltage in the servo amplifier 50 is lower than the second specified value, the servo motor control unit 20 follows the aforementioned step S45, step S19 and step S20 and the servo control ends.

Note that, in the present embodiment, after the power supply to the servo amplifier 50 is cut off, if due to some abnormality the direct-current voltage in the servo amplifier 50 decrease and the power supplied to the servo motor 11a is insufficient, the servo control becomes unstable, and therefore, there is a risk that the movable part driven by the servo motor 11a will deviate from the previously programmed trajectory. The aforementioned step S41 and step S42 can prevent such an occurrence in advance.

Further, in the aforementioned step S42, if the direct-current voltage in the servo amplifier 50 exceeds the second specified value, the servo motor control unit 20 judges whether the position of the shaft of the servo motor 11a detected by the position detector 12a exceed a maximum control stopping distance Doff (refer to a reference number 81 in FIG. 9) (step S43). Specifically, after the operation command output part 23 has detected the emergency stop signal, the actual position data of the servo motor 11a is continued to be monitored by the actual position monitoring unit 24. In other words, the actual position monitoring unit 24 monitors the position of the shaft of the servo motor 11a detected by the position detector 12a, and detect whether the servo motor 11a is coasting or not. Accordingly, if the position of the shaft of the servo motor 11a detected by the position detector 12a exceeds the predetermined maximum control stopping distance Doff (refer to the reference number 81 in FIG. 9), the servo controller 20 follows step S45, step S19 and step S20 and the servo control ends.

Further, in the aforementioned S43 if the position of the shaft of the servo motor 11a detected by the position detector 12a does not exceed the maximum control stopping distance Doff (refer to the reference number 81 in FIG. 9), the servo motor control unit 20 judges whether or not the time taken from the detection of the emergency stop signal to carry out the stop control exceeds the maximum control stop time Toff (refer to a reference number 82 in FIG. 9) (step S44). Specifically, the operation command output part 23 monitors the time taken from the detection of the emergency stop signal to when the stopping operation command reaches zero. Further, if the time from when the emergency stop signal is detected by the operation command output part 23 to when the stop control is carried out exceeds the maximum control stop time Toff (refer to the reference number 82 in FIG. 9), the servo controller 20 follows the aforementioned step S45, step S19 and step S20 and the servo control ends.

Note that, in the second control flow discussed above with reference to FIG. 7, after detecting the stop signal, if the servo amplifier 50 is not in a regenerative state but the maximum retention time Tc is exceeded by the time the electromagnetic contactor 61 is closed, the servo motor control unit 20 opens the contacts of the electromagnetic contactor 61 to thereby cut off the power supply to the servo amplifier (refer to the time chart of the electromagnetic contactor in FIG. 9). However, the maximum retention time Tc, which is a threshold to judge the length of time that the electromagnetic contactor 61 is closed (refer to a reference number 83 in FIG. 9), may be set to be the same as the aforementioned maximum control stop time Toff (refer to the reference number 82 in FIG. 9).

Furthermore, in the aforementioned step S44, if the time taken from the detection of the emergency stop signal to when the stop control is carried out does not exceed the maximum control stop time Toff (refer to the reference number 82 in FIG. 9), the servo motor control unit 20 judges whether or not the stop control has ended (step S18). Specifically, the servo motor control unit 20 judges whether the stopping operation command output from the operation command output part 23 is zero. If the stopping operation command output is zero, the servo motor control unit 20 follows the aforementioned step S19 and step S20 and the servo control ends.

If the conditions for ending the servo control are not met in the aforementioned steps S41 to S44 and step S18, the control returns to step S13 of the stop control flow illustrated in FIG. 2. Then, the servo controller 20 again follows steps S13 to S17 of FIG. 2, steps S41 to S44 and step S18 of FIG. 8 and the servo control is maintained.

Note that, at least one of the first control flow, second control flow and third control flow respectively shown in FIG. 5, FIG. 7 and FIG. 8 should be applied to the stop control flow of FIG. 2.

The above indicated embodiments are typical. However the present invention is not limited to such embodiments and the shape, configuration and materials may be changed within a range not deviating from the spirit of the present invention.

### The Effects of the Present Invention

According to the first aspect of the present invention, the power supply to the servo amplifier is cut off when the servo amplifier enters a regenerative state after the emergency stop signal is detected. In other words in the present invention, the power supply to the servo motor is maintained from when the emergency stop signal is detected until the stopping operation command switches to the decelerate operation (regenerative operation). Accordingly, if an emergency stop signal is input during the acceleration operation of the servo motor, the problem of the direct-current voltage decreasing in the servo amplifier as in a conventional emergency stop method does not occur. Therefore, according to the first aspect of the present invention, even if an emergency stop signal is inputted while the servo motor is accelerating, the servo motor can be stopped safely.

According to the second aspect of the present invention, in response to the detection of the emergency stop signal, after the power supply to the servo amplifier has been cut off, the regenerative electric power charged to the charge/discharge part of the servo amplifier maintains the stop control based on the stopping operation command until the stop control ends. Accordingly, even if the power supply to the servo amplifier is cut off, the servo motor can be safely and smoothly stopped. Accordingly, not only can vibrations and impacts to a machine tool, decelerator, electromagnetic brake, etc. during an emergency stop be eliminated but interference between the movable parts driven by the servo motor and surrounding equipment or an object to be machined can also be prevented. Furthermore, the safety to workers in the periphery of the machine is improved and the repair works for the reoperation of the machine is also simplified.

According to the third aspect of the present invention, if the time from detecting the emergency stop signal in which the power supply to the servo amplifier is secured, exceeds a predetermined maximum retention time, the power supply to the servo amplifier is forcibly cut off. Accordingly, the power supply to the servo amplifier can be forcibly cut off without waiting for switching the servo amplifier from a power running state or a coasting state to a regenerative state in the highest priority to safety.

According to the fourth aspect of the present invention, if a stopping operation command switches the servo motor from a regenerative state to a power running state again, a safe stop control can be maintained by restoring the power supply to the servo amplifier.

According to the fifth to eighth aspects of the present invention, if it is detected that the movable part driven by the servo motor is in a state in which there is a risk of deviation from a previously programmed trajectory, the stop control is forcibly interrupted and the electromagnetic brake or the regenerative brake are enabled. Thus, since such a risk can be prevented in advance, the safety of workers in the vicinity of the machine can be improved and repairs for restarting the operation of the machine can be simplified.

According to the ninth aspect of the present invention, after detecting an emergency stop, the electromagnetic brake or the regenerative brake is enabled when the stop control ends. Accordingly, since vibrations or impacts during an emergency stop can be completely eliminated, the servo motor can be safely and smoothly stopped.

1. A servo motor stop controller which stops and controls at least one servo motor which drives a movable part of a machine tool or a robot, during an emergency stop, comprising:
a position detector which detects the axial position of the servo motor;
at least one servo amplifier which drives the servo motor;
at least one servo power supply circuit which supplies power to the servo amplifier;
a servo motor control unit which controls the servo motor via the servo amplifier based on the axial position detected by the position detector;
an electromagnetic brake or a regenerative brake which brakes the shaft rotation of the servo motor; and
an emergency stop signal output part, provided on the outside or inside of the servo motor control unit, outputting an emergency stop signal,
wherein
the servo motor control unit comprises:
an operation command output part which detects the emergency stop signal, and generates and outputs a stopping operation command to stop the servo motor;
a regenerative state detection part which detects the regenerative state of the servo amplifier; and
a power supply circuit control part which controls the servo power supply circuit and supplies or cuts off power to the servo amplifier,
wherein,
when the operation command output part detects the emergency stop signal, the stopping operation command is output to the servo amplifier, and in the step of stop control based on the stopping operation command, the regenerative state of the servo amplifier is detected by the regenerative state detection part,
the power supply circuit control part is configured to control the servo power supply circuit whereby the supply of power to the servo amplifier is cut off.

2. The servo motor stop controller according to claim 1, wherein
the servo amplifier further comprises a charge/discharge part which is charged by the regenerative current generated during the deceleration operation of the servo motor,
wherein,
after the power supply to the servo amplifier has been cut off, the servo motor control unit is configured to continue the stop control based on the stopping operation command until the stop control ends, by use of the regenerative electric power charged to the charge/discharge part of the servo amplifier.

3. The servo motor stop controller according to claim 1, wherein,
if the duration of the servo power supply circuit maintaining the power supply to the servo amplifier, from the detection of the emergency stop signal by the operation command output part, exceeds a predetermined maximum retention time,
the power supply circuit control part controls the servo power supply circuit and forces the power supply to the servo amplifier to be cut off.

4. The servo motor stop controller according to claim 1, wherein,
after the power supply circuit control part controls the servo power supply circuit to interrupt the power supply to the servo amplifier in response to the detection of the servo amplifier being in a regenerative state by the regenerative state detection part, if the regenerative state detection part detects that the servo amplifier is in a power running state,
the power supply circuit control part controls the servo power supply circuit to restore the power supply to the servo amplifier and the servo motor control unit is configured to continue the stop control based on the stopping operation command until the end of the stop control.

5. The servo motor stop controller according to claim 1, wherein,
after the detection of the emergency stop signal, if a position deviation amount, which is calculated from the stopping operation command and the shaft position of the servo motor detected by the position detector, exceeds a first specified value during the period from when the servo motor control unit carries out the stop control based on the stopping operation command to when the servo motor control unit terminates the stopping operation,
the servo motor control unit is configured to interrupt the output of the stopping operation command, enable the electromagnetic brake or the regenerative brake, and switch off the power to the servo motor.

6. The servo motor stop controller according to claim 1, wherein,
after the detection of the emergency stop signal, if the direct current voltage in the servo amplifier is less than a second specified value during the period from when the servo motor control unit carries out the stop control based on the stopping operation command to when the servo motor control unit terminates the stop control,
the servo motor control unit is configured to interrupt the output of the stopping operation command, enable the electromagnetic brake or regenerative brake, and switch off the power to the servo motor.

7. The servo motor stop controller according to claim 1, wherein,
after the detection of the emergency stop signal, if the shaft position of the servo motor detected by the position detector exceeds a predetermined maximum control stopping distance during the period from when the servo motor control unit carries out the stop control based on the stopping operation command to when the servo motor control unit terminates the stop control,
the servo motor control unit is configured to interrupt the output of the stopping operation command, enable the electromagnetic brake or the regenerative brake, and switch off the power to the servo motor.

8. The servo motor stop controller according to claim 1, wherein,
after the detection of the emergency stop signal, if the time for carrying out the stop control exceeds a predetermined maximum control stop time during the period from when the servo motor control unit carries out the stop control based on the stopping operation command to when the servo motor control unit terminates the stop control,
the servo motor control unit is configured to interrupt the output of the stopping operation command, enable the electromagnetic brake or the regenerative brake, and switch off the power to the servo motor.

9. The servo motor stop controller according to claim 1, wherein,
after the detection of the emergency stop signal, when the servo motor control unit has carried out the stop control based on the stopping operation command, and terminated the stop control,
the servo motor control unit is configured to enable the electromagnetic brake or the regenerative brake and switch off the power to the servo motor.
